(19) United States
(12) Patent Application Publication
(10) Pub. No.: US 2009/0313896 A1
(43) Pub. Date: Dec. 24, 2009

(54) HYDROGEN GENERATION AND DISTRIBUTION SYSTEM

(76) Inventor: Cameron Glidewell, Los Angeles, CA (US)

Correspondence Address: ITALIA IP, 3500 WEST OLIVE AVE., SUITE 300, BURBANK, CA, 91505, US

(21) Appl. No.: 12/142,977

(22) Filed: Jun. 20, 2008

(51) Int. Cl. F17D 1/04; H02J 7/34

(52) U.S. Cl. 48/190; 307/48

(57) ABSTRACT

A hydrogen production and distribution system which may exploit pre-existing energy infrastructure such as offshore hydrocarbon production facilities, sewage treatment plants, and natural gas pipelines. The offshore facilities and sewage treatment plants may have wind turbines, photovoltaic elements, and wave powered generators to generate electricity, which is then stored in batteries. Electrical power is drawn from the batteries to electrolyze water. Hydrogen collected from electrolysis is conducted to consumers through a system using the natural gas pipelines and optionally, tank trucks formerly used to deliver propane gas. A master computerized control system controls the hydrogen production and distribution system, and is isolated from public communications channels.

### FIELD OF THE INVENTION

The present invention relates to a system for generating and distributing hydrogen gas as an energy resource.

### BACKGROUND OF THE INVENTION

The United States presently relies on hydrocarbon fuels such as liquid petroleum products and natural gas for much of its energy needs. This is due mainly to historic bountiful domestic hydrocarbon resources and low costs of hydrocarbon fuels.

However, increasing world wide demand and depletion of domestic resources are forcing prices up. Also, environmental concerns ranging from the possibility that use of hydrocarbon fuels are contributing to greenhouse gas increases in the atmosphere to air pollution stemming from incomplete burning of hydrocarbon fuels lead to a conclusion that other fuel sources should be used.

Hydrogen gas is a known potential fuel having certain advantages. One is that it presents no known greenhouse gas consequences when burned as a fuel. Another is that due to its wide flammability limits, it tends to burn to completion, thereby generating little if any pollution. So from an environmental standpoint, hydrogen is an ideal fuel.

Also, hydrogen is plentiful in that water contains hydrogen.

Hydrogen does not occur naturally and hence must be generated using energy resources. Hydrogen may be obtained from hydrocarbons, but that utilizes expensive hydrocarbons in addition to energy. Electrolysis of water offers a virtually inexhaustible source of energy, but requires electrical energy inputs. Once generated, hydrogen requires distribution to the point of use. While a hydrogen distribution system could be built as new, this would prove prohibitively expensive.

There exists a need for a system which will provide energy having no detrimental environmental effects while enabling a large scale supply of hydrogen to be generated and inexpensively distributed to the point of use.

### SUMMARY OF THE INVENTION

The present invention answers the above need by providing a hydrogen generating and distribution system which uses solar energy as an energy source, and which minimizes the amount of new infrastructure which must be constructed. To this end, the system comprises direct solar generation facilities such as wind turbines and photovoltaic collectors and indirect solar based generation apparatus such as wave powered generators, located on pre-existing infrastructure. The system stores generated electricity and uses this energy to electrolyze water such as seawater for distribution throughout the United States. The distribution system utilizes pre-existing gas pipelines which, prior to implementation of a hydrogen distribution system, are used for distributing natural gas.

The system may be controlled by a master computer system using communications links which are separated from general communications networks such as the internet.

It is an object of the invention therefore to provide a hydrogen energy supply system based ultimately on solar energy and is relatively inexpensive.

It is another object of the invention to provide a hydrogen distribution system which is relatively inexpensive.

A further object of the invention is provide a secure control system for the hydrogen generating and distribution system.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic overview of a system for generating and distributing energy according to at least one aspect of the invention.

FIG. 2 is a diagrammatic environmental side view of a marine generating station which may be used in the system of FIG. 1.

FIG. 3 is a diagrammatic environmental top plan view of a marine generating station which may be used in the system of FIG. 1.

FIG. 4 is a diagrammatic environmental side view of a land based generating station which may be used in the system of FIG. 1.

FIG. 5 is diagrammatic environmental top plan detail view of a portion of the system of FIG. 1.

FIG. 6 is a diagrammatic representation of a communications system which may be used with the system of FIG. 1.

FIG. 7 is a block diagram showing steps of a method of providing a system for generating and distributing energy, and is read starting at the upper left.

### DETAILED DESCRIPTION

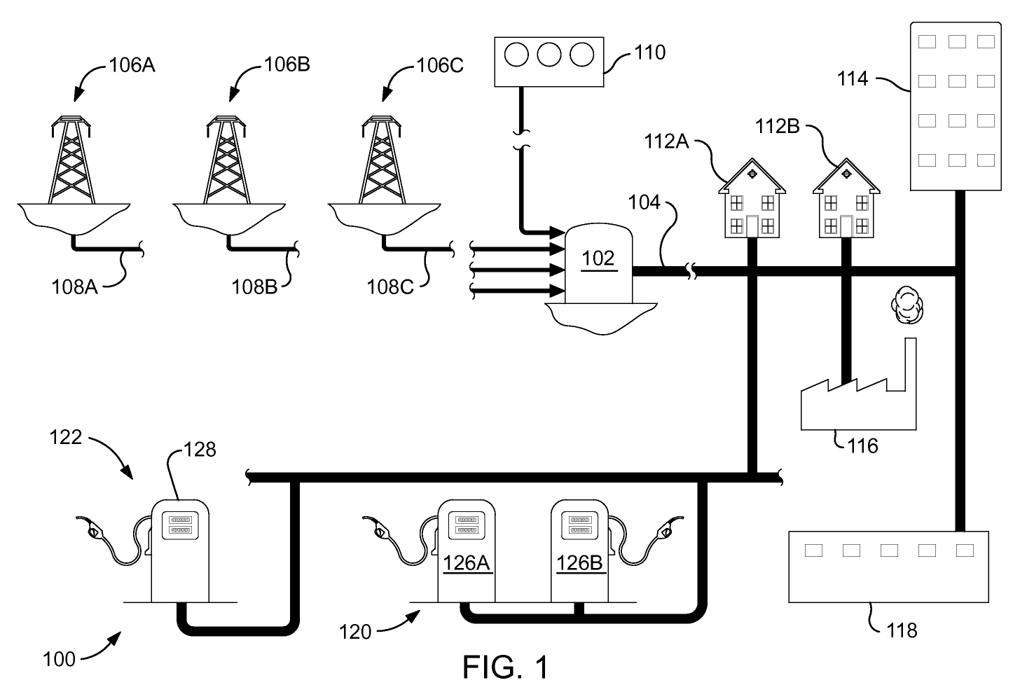

FIG. 1 of the drawings shows an overview of a system 100 for generating and distributing energy in the form of hydrogen gas. The system 100 has two salient characteristics. One is that hydrogen is generated by electrolysis of water using natural energy to generate electricity. Natural energy is to be regarded as energy derived from a source which is immune to depletion, such as solar energy or deep sourced geothermal energy. The second is that the system 100 utilizes existing energy infrastructure to the greatest extent feasible, so as not to incur objectionable costs. To this end, the system 100 may utilize for example tanks such as a tank 102 and a pipeline distribution system 104 including pre-existing sections which were formerly used to store and conduct natural gas. The pipelines distribution system is connected to the hydrogen gas collection system and to individual consumers of hydrogen gas, as will be described hereinafter.

Energy for electrolysis is generated at pre-existing facilities which now may be used for generating hydrogen. One type of facility is an offshore hydrocarbon production facility such as an offshore petroleum or natural gas drilling and recovery platform, shown representatively as offshore facilities 106A, 106B, and 106C, which have petroleum or gas pipelines or transfer apparatus 108A, 108B, and 108C, the latter coming into play should the product be loaded into ships (not shown) rather than transported through pipelines.

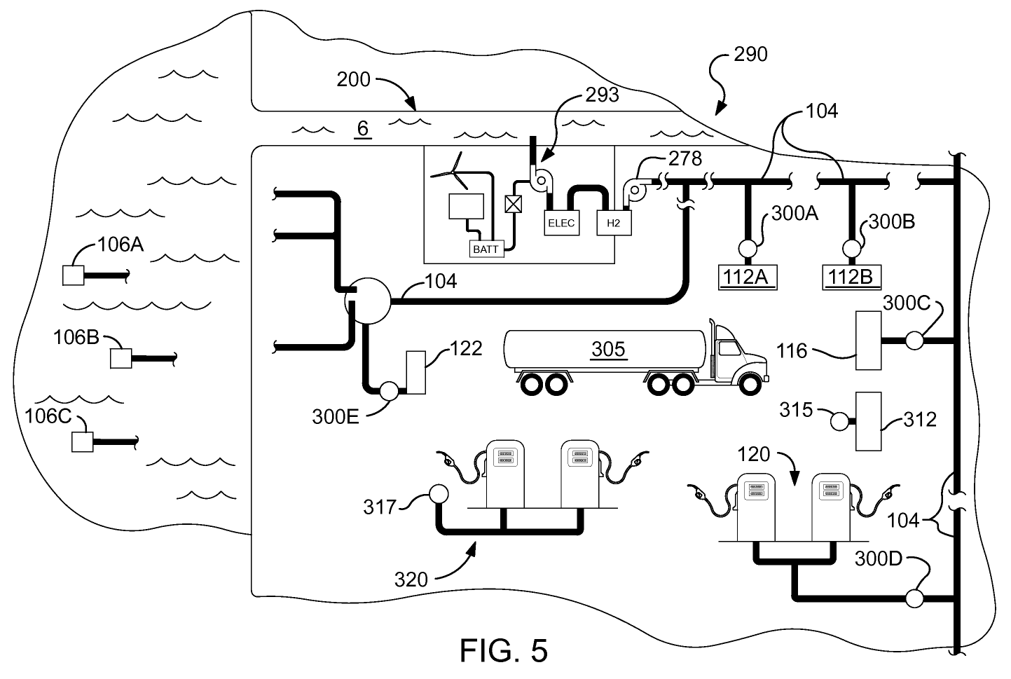

Electricity for performing electrolysis may also be generated at an onshore facility such as a sewage treatment plant 110. Both the offshore facilities 106A, 106B, and 106C and the sewage treatment plant 110 discharge hydrogen produced by electrolysis into tanks or conduits associated with the pipeline distribution system 104 for further distribution. Hydrogen may be distributed by the pipeline distribution system 104 to homes 112A, 112B, multi-unit residences such as an apartment building 114, factories such as a factory 116, institutional buildings such as schools, hospitals, government facilities, retail buildings, and others. These are shown representatively as an institutional building 118. Hydrogen gas is also conducted to retail outlets such as a retail outlet 120 and to bulk or wholesale outlets such as a bulk outlet 122. Retail outlets such as the retail outlet 120 have pumps or dispensers 126A and 126B for delivering hydrogen gas directly to a motor vehicle (not shown) which is owned or operated by a consumer. Bulk outlets such as the bulk outlet 122 has one or more pumps or dispensers 128 for loading into a truck (an exemplary truck is shown in FIG. 5) so that hydrogen can be transported to and unloaded at the premises of a residential, commercial, industrial, or institutional consumer whose premises are not connected to the pipeline distribution system 104.

It is intended that the pipeline distribution system 104 span much if not all of the United States. The pipeline distribution system 104 will be understood to encompass pipes and other conduits, tanks, valves, meters, pressure regulators, fire suppressors, pumping blowers, cooling apparatus, gas additive apparatus for BTU stabilization, and other support function apparatus as may be necessary.

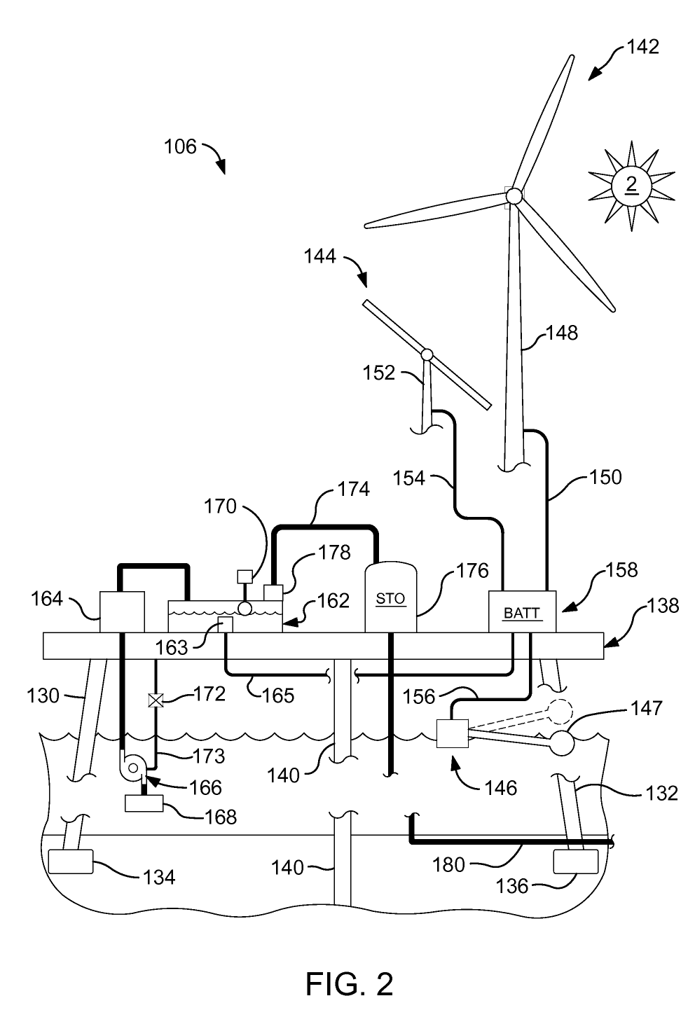

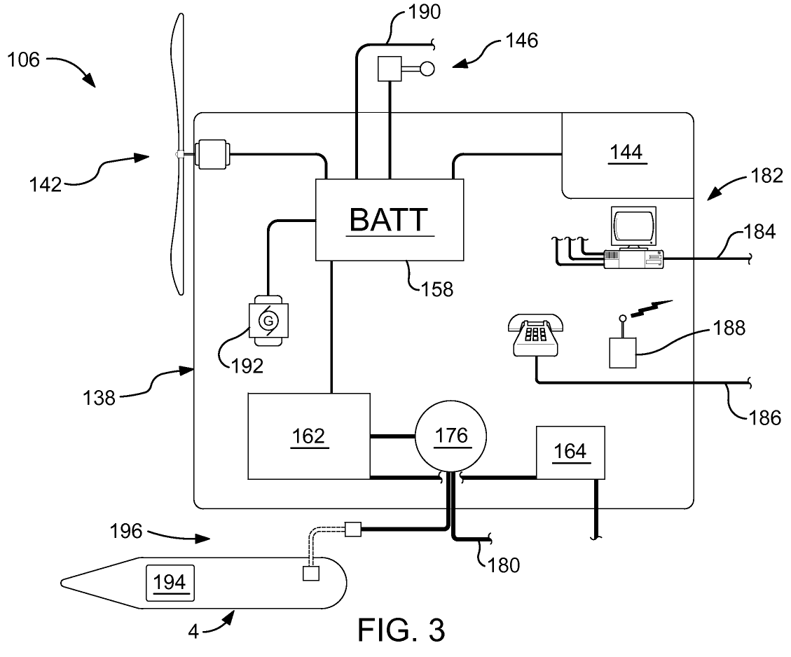

FIG. 2 shows details of an offshore facility such as an offshore facility 106 (facilities 106A, 106B, and 106C, introduced earlier, are to be regarded as typical of the offshore facility 106), according to one or more aspects of the invention. Most but not all of the features of the offshore facility 106 are shown in FIG. 2. Additional features are shown in FIG. 3.

The offshore facility 106 may be pre-existing, such as a pre-existing hydrocarbon production facility which was formerly used to extract hydrocarbons from beneath the ocean floor. The offshore facility 106 may comprise legs 130 and 132 and associated anchorage members 134 and 136, a working platform 138, and may have residual hydrocarbon recovery apparatus such as for example, a pipestring 140.

For purposes of producing hydrogen, the offshore facility 106 may have natural energy using devices for generating electricity. Illustratively, these may include a wind turbine assembly 142, a photovoltaic collector 144, and a wave powered generator 146. The wind turbine assembly 142 may be mounted on the platform 138 by a mast 148, and will be understood to include a generator (not separately shown) and circuitry 150 necessary to perform the described functions. Similarly, the photovoltaic collector 144 may be mounted to the platform 138 by a mast 152 and have circuitry 154 to perform the described functions. The wave powered generator 146 will also be understand to include a suitable mounting arrangement (not shown) and circuitry 156 to perform described functions. It may be mentioned here that the different types of natural energy using devices may operate simultaneously and independently of one another. Normally, the wind turbine assembly 142 will generate power when the wind blows. The photovoltaic collector 144 will generate power when the sun 2 shines regardless of wind conditions. The wave generator 146 may be of the type which has a float 147 or other movable member which is displaced by passing waves (not shown).

Electrical power obtained by the aforementioned generating sources may be conducted to and stored in a suitable battery pack such as the battery pack 158. The battery pack 158 may comprise one or more type of power storing device, such as an electrochemical cell or cells, a capacitor of any known type including for example supercapacitors or ultracapacitors, or any combination and number of these.

The battery pack 158 is connected by suitable circuitry 160 to an electrolysis facility 162, which derives operating power from the battery pack 158. The electrolysis facility 162 will be understood to include all necessary positive and negative electrodes (shown representatively as a single electrode 163), circuitry 165 connected to the battery pack 158, one or more liquid tanks, and other apparatus necessary for successful operation. Electrolysis is a well known process and therefore, specific details will not be presented herein.

The liquid subject to electrolysis may be seawater, obtained from the ocean by a suitable pumping system 164. The pumping system 164 may include a submersible pump 166 which is connected to a water pickup 168 having a protective screen to prevent foreign objects such as sea creatures and debris from entering the system. The submersible pump 166 may be controlled by a float switch 170 which is set to maintain a predetermined liquid level within the electrolysis facility 162. The float switch 162, which will be understood to include all necessary supporting apparatus, may provide inputs to a motor controller such as a motor starter 172 which in turn controls the power circuit 173 serving the motor (not separately shown) of the submersible pump 166.

Hydrogen produced or released by electrolysis may be collected from the electrolysis facility 162 and conducted in a conduit 174 for delivery to a hydrogen storage tank 176. The hydrogen gas may be pressurized by a blower or compressor 178 before or after collection in the storage tank 176, and conducted to the pipeline distribution system 104 by a suitable conduit 180. The conduit 180 may lie on the sea floor, may be buried within the sea floor, may be supported above the sea floor, or any combination of these.

FIG. 3 shows other features of the offshore facility 106. A computer terminal 182 or other data processing device for operating the hydrogen production equipment of the offshore facility 106 is provided in a suitably protected location. A communications link 184 connects the computer terminal 182 to a larger supervisory system (further described with reference to FIG. 6). It is important to note that the communications link 184 is separate and apart from general purpose communications channels available to the public, such as a telephone land line system 186 which is provided for general communications to the shore, and radio equipment such as a UHF marine band radio 188, provided for communication with the Coast Guard and ships which may be in the area of the offshore facility 106. An emergency power supply circuit 190 may be connected to onshore electrical power for standby duty, as power from the battery pack 158 will be the primary source of power for all operations, and an onboard emergency diesel generator set 192 may be provided also.

FIG. 3 also shows an arrangement generally indicated as 196 for hydrogen to be loaded from the storage tank 176 to a ship 4, should it be desired to transfer hydrogen by ship. The ship 4 may also have a photovoltaic collector 194 to serve the cryogenic system which is used to increase density of transported hydrogen.

It should be mentioned at this point that there are potentially useful products of electrolysis which may also be exploited economically. For example, electrolysis of water produces both hydrogen and oxygen. The oxygen released by electrolysis may be retained and delivered to users thereof using for example a pipeline system (not shown) which operates in parallel to that which conducts hydrogen. Users of oxygen may possibly be different from users of hydrogen, or may use oxygen for purposes other than reacting with hydrogen. Because of its wide limits of flammability, hydrogen may be combusted using atmospheric air. Oxygen may be reserved for use with what would otherwise be unusable fuels. Illustratively, municipal garbage, which may be uncombustible using atmospheric air, or which may produce objectionable products of combustion using atmospheric air, may combust satisfactorily in a pure oxygen atmosphere.

Also, in the case of sea water, continued electrolysis of sea water will cause salt (sodium chloride) and other minor solids content, such as silica and calcium carbonate, to become concentrated in seawater being electrolyzed. These solids may be retained and exploited economically by delivering them to users.

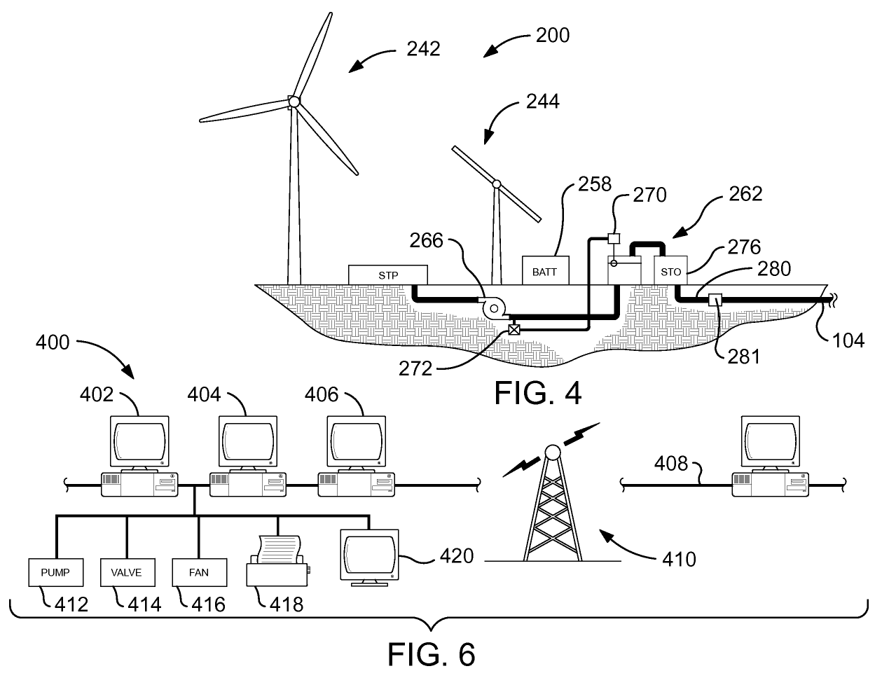

FIG. 4 shows another type of pre-existing facility which may be utilized for hydrogen generation. A conventional sewage treatment plant 200 may be modified to be incorporated into the hydrogen production system which is the object of the present invention by installing at least one power generating wind turbine assembly 242 and at least one photovoltaic collector 244. Conventional sewage treatment plants have structure such as settling ponds (not separately shown) which occupy significant land area. This land area can be utilized to provide the above electrical generating elements advantageously as no additional land area must be solely dedicated thereto, and no energy inputs are demanded as the wind turbine assembly 242 and the photovoltaic collector 244 rely upon direct or indirect unused solar power. Sewage treatment plants also present a source of water for electrolysis in that most of their wastewater, once treated, will subsequently be discharged to rivers and other waterways.

To this end, wastewater is conducted to an electrolysis facility 262 by a conduit and pump 266. The level of water within the electrolysis facility 262 is monitored by a float switch 270, which in turn controls the motor controller 272 which starts and stops the pump 266 to assure appropriate water supply.

The wind turbine assembly 242 and at least one photovoltaic collector 244 are connected by suitable circuitry (not separately shown) to a battery pack 258 by additional circuitry (not separately shown) to enable electrical power to be made available for electrolysis. Hydrogen released by electrolysis is collected and conducted to a storage tank 276 for connection to the pipeline distribution system 104 through a conduit 280. The conduit 280 communicably connects to the pipeline distribution system 104 at a suitable interface, represented as 281.

In summary, the sewage treatment plant 200 may serve as a pre-existing onshore counterpart to the offshore facility 106, adapted for differences arising from location on land instead of at sea, such as being adapted to provide water for electrolysis and ground area suitable for operating wind driven generators such as the wind turbine assembly 242 and photovoltaic elements such as the photovoltaic collector 244.

With reference to FIG. 4, the system 100 is controlled by a suitable master computerized control system, such as a wide area network (WAN) 400, which is adapted to perform administrative functions relative to conducting and delivering hydrogen gas. The WAN 400 may include individual terminals such as the terminals 402, 404, and 406 located at each generating site (such as the offshore facility 106), at distribution facilities (not separately shown), at administrative centers (not shown), and at other facilities which are part of the system 100. Although symbolically depicted as personal computers (PCs), the terminals 402, 404, and 406 may take any form, and need not be identical to one another. For example, the terminals 402, 404, and 406 may be PCs, mainframe computers, portable or hand held electronic devices such as the type known as personal digital assistants, may incorporate communications capabilities, such as devices known as cellular phones, and may be programmable. The WAN 400 may utilize hard wired communications channels, such as the channel 408, or secured wireless communications channels, such as the radio link 410.

Security is an important issue as a national energy delivery system is an aspect of the national security. In light of this, the entire communications channel system, including both hard wired and wireless communications channels, is maintained out of communicable relation to public communications channels such as the internet.

The WAN 400 performs necessary administrative tasks such as monitoring inventory of hydrogen and if desired, oxygen, and managing systems components such as pumps (such as the pump 412), valves (such as the valve 414), and fans and compressors (such as the fan 416). The WAN 400 may include data displaying and transferring apparatus such as printers (such as the printer 418) and display screens (such as the display screen 420). The data handled by the WAN 400 may encompass personnel issues such as payroll and vacation time, administrative issues such as taxes and statistical reporting, and maintenance functions such as maintenance scheduling, replacement parts inventorying, and ordering of supplies, and the like.

FIG. 5 illustrates diagrammatically how the offshore facilities 106A, 106B, and 106C, and onshore facility provided by the sewage treatment plant 200 may be integrated into a part of the pipeline distribution system 104 at a representative site, and shows further details of the pipeline distribution system 104. The offshore facilities 106A, 106B, and 106C are connected to the pipeline distribution system 104. Hydrogen gas provided thereby is supplemented by connection of hydrogen generated at the sewage treatment plant 200, this connection shown representatively as 290. The hydrogen gas may be pressurized by a compressor 278.

A further operating detail of the sewage treatment plant 200, which is available to sewage treatment plants located within reasonable proximity to natural waterways such as a river 6, is that water may be inducted to the hydrogen generating system through a water pickup 293 located in the river 6 in addition to or instead of using wastewater which conventionally is discharged from the sewage treatment plant 200.

In FIG. 5, it is seen that individual consumers of hydrogen supplied from the pipeline distribution system 104, such as the residences 112A and 112B and the factory 116 each has a respective gas meter 300A, 300B, or 300C. Of course, other large consumers such as the apartment 114 and the institutional building 118 will be connected similarly to the factory 116.

Retail outlets, such as the retail outlet 120, may have a master meter 300D, with individual meters (not shown) provided for determining deliveries of hydrogen for each individual purchase.

Bulk outlets, such as the bulk outlet 122, which may have its own master meter 300E, may serve consumers which are not directly connected to the pipeline distribution system 104. One or more tank trucks 305 may be supplied with hydrogen at the bulk outlet 122 and may drive to remote or unconnected consumers such as a residence 312 having a hydrogen storage tank 315. The tank truck 305, which is adapted to receive, store, and deliver hydrogen gas to a consumer, may be a modified truck formerly used to deliver propane to consumers, for example.

Metering may be performed by a meter which is integral with the storage tank 315 or may be performed by a meter which is integral with the truck 305. Unconnected retail outlets for hydrogen, such as the retail outlet 320, which in other ways may be similar to the retail outlet 120, may be similarly supplied, using a master hydrogen receiving and holding tank 317.

Thus at least some individual consumers (such as the residence 112A) having premises which are connected to the pipeline distribution system 104 may have meters (such as the meter 300A), and at least some individual consumers (such as the residence 312) may have meters.

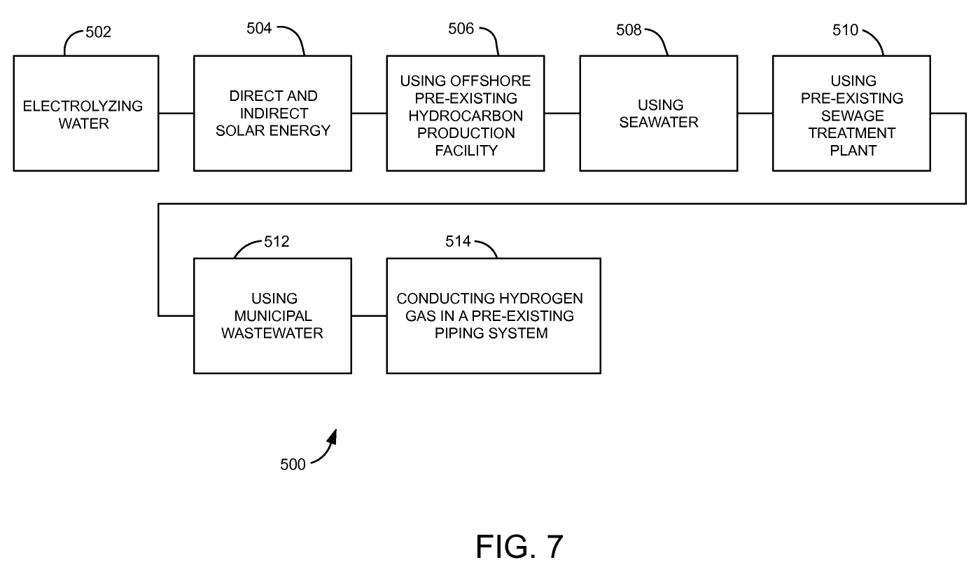

According to a further aspect of the invention, and referring now to FIG. 7, the invention may comprise a method 500 of providing hydrogen as an energy resource to consumers. The method 500 may comprise:

a step 502 of electrolyzing water to produce hydrogen gas;

a step 504 of using at least one of direct solar energy and indirect solar energy to generate electricity for electrolysis of water;

a step 506 of using an offshore pre-existing hydrocarbon production facility as a platform for locating at least one of direct solar energy generating apparatus and indirect solar energy generating apparatus;

a step 508 of using seawater as a source of water to be electrolyzed;

a step 510 of using at least one pre-existing sewage treatment plant as a platform for locating at least one of direct solar energy generating apparatus and indirect solar energy generating apparatus;

a step 512 of using municipal wastewater as a source of water to be electrolyzed; and

a step 514 of conducting hydrogen gas produced by electrolysis to at least one consumer using at least in part a pre-existing piping system which was formerly used to conduct natural gas.

The invention is susceptible to variations and modifications which may be introduced thereto without departing from the inventive concept. For example, it is to be understood that due to the conceptual description presented herein, components presented in the singular may be provided in the plural. This includes for example generators at any one generating site, whether of the wind turbine, wave, or photovoltaic type, the numbers of generating sites, and also other support apparatus such as conduits and electrical power and signal conductors, pumps, switches, sensors, valves, tanks, and any other components of a system according to one or more aspects of the invention. Circuitry will be understood to comprise the number of conductors, and specific connection schemes necessary to carry out the described functions, as well as supporting apparatus such as switches, relays, transducers, circuit breakers, transformers, and voltage dividers, among others.

It would be possible to generate hydrogen immediately upon generating electricity from the various generating apparatus, and to store the generated hydrogen, rather than storing electrical power and deferring electrolysis of water by withdrawing stored electrical power. If desired, both of the methods (i.e., immediate electrolysis and deferred electrolysis) may be employed.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A system for generating and distributing energy, comprising:
an electrical generating facility comprising at least two natural energy using devices of different types for generating electricity,
a battery pack connected to electricity generated by the natural energy using device,
an electrolysis facility connected to the battery pack so as to be able to derive operating power from the battery pack,
a hydrogen gas collection system operably connected to the electrolysis facility to collect hydrogen gas released by electrolysis; and
a hydrogen distribution facility further comprising a pipeline distribution system.

2. The system according to claim 1, wherein the natural energy using devices include at least one of a wind turbine, a photovoltaic element, and a wave powered generator, and wherein the natural energy using devices are disposed to be able to generate electricity simultaneously, and wherein simultaneously generated electricity is transmitted to the battery pack.

3. The system according to claim 1, wherein the pipeline distribution system extends to individual consumers and further comprises meters disposed to meter delivered hydrogen for at least some individual consumers who have premises connected to the pipeline distribution system.

4. The system according to claim 1, wherein the pipeline distribution system further comprises at least one tank truck adapted to receive, store, and deliver hydrogen gas to a consumer.

5. The system according to claim 1, further comprising a master computerized control system adapted to perform administrative functions relative to conducting and delivering hydrogen gas.

6. The system according to claim 5, wherein the master computerized control system comprises a dedicated communications channel system which is maintained out of communicable relation to public communications channels.

7. A system for generating and distributing energy, comprising:
at least one offshore facility comprising
at least two natural energy using devices of different types for generating electricity,
a battery pack connected to electricity generated by the natural energy using device,
an electrolysis facility connected to the battery pack to be able to derive operating power from the battery pack,
a hydrogen gas collection system operably connected to the electrolysis facility to collect hydrogen gas released by electrolysis,
a pumping system adapted to obtain water from the ocean and to conduct collected water to the electrolysis facility; and
a pipeline distribution system connected to the hydrogen gas collection system and to individual consumers of hydrogen gas, wherein at least part of the pipeline distribution system is pre-existing and was formerly used to conduct natural gas.

8. The system according to claim 7, wherein the natural energy using devices include at least one of a wind turbine, a photovoltaic element, and a wave powered generator.

9. The system according to claim 7, wherein the offshore facility comprises a pre-existing hydrocarbon production facility which was formerly used to extract hydrocarbons from beneath the ocean floor.

10. The system according to claim 7, wherein at least two of the natural energy generating devices are disposed to generate electricity simultaneously, and electricity which was simultaneously generated thereby is transmitted to the battery pack.

11. The system according to claim 7, wherein the pipeline distribution system further comprises meters for at least some individual consumers.

12. The system according to claim 7, wherein the pipeline distribution system further comprises at least one tank truck adapted to receive, store, and deliver hydrogen gas to a consumer.

13. The system according to claim 7, further comprising a master computerized control system adapted to perform administrative functions relative to conducting and delivering hydrogen gas.

14. The system according to claim 7, further comprising a pre-existing sewage treatment plant adapted to provide water for electrolysis and ground area suitable for operating photovoltaic elements, the system further comprising
a second photovoltaic element located onsite at the pre-existing sewage treatment plant,
a second battery pack located onsite at the pre-existing sewage treatment plant, and
a second electrolysis facility located onsite at the pre-existing sewage treatment plant,
wherein hydrogen gas generated by electrolysis at the second electrolysis facility is connected to the pipeline distribution system.

15. A system for generating and distributing energy, comprising:
at least one offshore facility comprising a pre-existing hydrocarbon production facility which was formerly used to extract hydrocarbons from beneath the ocean floor, the offshore facility further comprising
at least two natural energy using devices of different types for generating electricity, wherein the natural energy using devices include at least one of a wind turbine, a photovoltaic element, and a wave powered generator, and the natural energy using devices are disposed to be able to generate electricity simultaneously,
a battery pack connected to electricity generated by the natural energy using device, and wherein electricity generated simultaneously by the natural energy using devices may be simultaneously received and stored by the battery pack,
an electrolysis facility connected to the battery pack to be able to derive operating power from the battery pack,
a hydrogen gas collection system operably connected to the electrolysis facility to collect hydrogen gas released by electrolysis,
a pumping system adapted to obtain water from the ocean and to conduct collected water to the electrolysis facility;
a pre-existing sewage treatment plant adapted to provide water for electrolysis and ground area suitable for operating photovoltaic elements, the system further comprising
a second photovoltaic element located onsite at the pre-existing sewage treatment plant,
a second battery pack located onsite at the pre-existing sewage treatment plant, and
a second electrolysis facility located onsite at the pre-existing sewage treatment plant,
wherein hydrogen gas generated by electrolysis at the second electrolysis facility is connected to the pipeline distribution system;
a pipeline distribution system connected to the hydrogen gas collection system and to individual consumers of hydrogen gas, wherein at least part of the pipeline distribution system is pre-existing and was formerly used to conduct natural gas, wherein the pipeline distribution system further comprises
pipes disposed to connect the electrolysis facility to individual consumers,
a plurality of meters for metering delivered hydrogen at the premises of at least some individual consumers, and
at least one tank truck adapted to receive, store, and deliver hydrogen gas to a consumer; and
a master computerized control system adapted to perform administrative functions relative to conducting and delivering hydrogen gas, including at a minimum the functions of firstly, operating valves to enable desired delivery of hydrogen gas throughout the pipeline distribution system and secondly, controlling excessive pressures which may develop within the pipeline distribution system, wherein the master computerized control system comprises a dedicated communications channel system which is maintained out of communicable relation to public communications channels.

16. A method of providing hydrogen as an energy resource to consumers, comprising the steps of:
electrolyzing water to produce hydrogen gas; and
conducting hydrogen gas produced by electrolysis to at least one consumer using at least in part a pre-existing piping system which was formerly used to conduct natural gas.

17. The method of providing hydrogen according to claim 16, comprising the further step of using at least one of direct solar energy and indirect solar energy to generate electricity for electrolysis of water.

18. The method of providing hydrogen according to claim 17, comprising the further steps of
using an offshore pre-existing hydrocarbon production facility as a platform for locating at least one of direct solar energy generating apparatus and indirect solar energy generating apparatus; and
using seawater as a source of water to be electrolyzed.

19. The method of providing hydrogen according to claim 16, comprising the further step of using at least one pre-existing sewage treatment plant as a platform for locating at least one of direct solar energy generating apparatus and indirect solar energy generating apparatus; and
using municipal wastewater as a source of water to be electrolyzed.
